(19) United States
(12) Patent Application Publication
(10) Pub. No.: US 2014/0172915 A1
(43) Pub. Date: Jun. 19, 2014

(54) SYSTEMS AND METHODS FOR SELECTIVELY PROVIDING ACCESS TO CONTENT

(71) Applicant: Jonathan Herbach, Mountain View, CA (US)

(72) Inventor: Jonathan Herbach, Mountain View, CA (US)

(73) Assignee: ADOBE SYSTEMS INCORPORATED, San Jose, CA (US)

(21) Appl. No.: 13/028,937

(22) Filed: Feb. 16, 2011

(51) Int. Cl. G06F 17/30; G06F 15/16

(52) U.S. Cl. 707/781; 709/217; 707/E17.008

(57) ABSTRACT

One illustrative embodiment involves receiving a content request for accessing a piece of content, the content request identifying the piece of content, the content request received by a first computer device, and the content request requesting access to the piece of content by a content requester. The embodiment further involves receiving information about the content requester and sending from the first computer device a requester-specific information request requesting additional information from the content requester based at least in part on information about the content requester. The embodiment further involves receiving the additional information at the first computer device and selectively, at the first computer device, providing access to the piece of content based at least in part on the additional information.

### FIELD

This disclosure relates generally to providing access to electronic content and more specifically to allowing access to various portions of electronic content selectively to content requesters based on information received about the content requesters.

### BACKGROUND

Various types of content can be accessed from data repositories or other storage systems. Existing storage systems often require users to input certain information to access content. Having to provide such information can deter users from obtaining the content because they may grow impatient if a large amount of seemingly irrelevant information is required. Moreover, in part because information collection is difficult, many systems are insensitive to a user's preferences for content. For example, requested content may contain portions that are irrelevant to a user or may be denied altogether because a portion of the content contains sensitive information that cannot be shared with the particular requesting user. Returning users can also be required to enter the same, voluminous information each time they request content. Existing techniques for requesting and using information in distributing and allowing access to electronic content are inadequate.

### SUMMARY

One illustrative embodiment involves receiving a content request for accessing a piece of content, the content request identifying the piece of content, the content request received by a first computer device, and the content request requesting access to the piece of content by a content requester. The embodiment further involves receiving information about the content requester and sending from the first computer device a requester-specific information request requesting additional information from the content requester based at least in part on information about the content requester. The embodiment further involves receiving the additional information at the first computer device and selectively, at the first computer device, providing access to the piece of content based at least in part on the additional information. This illustrative embodiment is mentioned not to limit or define the disclosure, but to provide an example to aid understanding thereof. Additional embodiments are discussed in the Detailed Description, and further description is provided there.

### BRIEF DESCRIPTION OF THE FIGURES

These and other features, aspects, and advantages of the present disclosure are better understood when the following Detailed Description is read with reference to the accompanying drawings, where:

FIG. 1 depicts an exemplary computing environment for selectively providing access to the piece of content.

FIG. 2 is a flow chart illustrating an exemplary computer-implemented method of controlling access to the piece of content.

FIGS. 3A-3D depict an exemplary user interface with dialogue boxes for displaying an information request and receiving a response thereto.

FIG. 4 is a flow chart illustrating an exemplary computer-implemented method of selecting a piece of content based on one or more responses to information requests.

FIG. 5 depicts an exemplary mapping of information requests and acceptable responses to information requests.

### DETAILED DESCRIPTION

Methods and systems are disclosed for providing selective access to whitepapers, documents, and other electronic pieces of content. In an exemplary embodiment, one or more requests for information can be sent to a user who requests access to a piece of content. Such requests for information may be requester-specific in that they request different information depending on the content requester to whom the request for information pertains. For example, a series of request for information and associated responses may be exchanged to elicit information from the content requester that is used to determine whether the requested content should be provided, which version of the content to provide, and whether all or only some portions of the electronic content should be provided.

Requests for information can thus extend beyond traditional user name and password requests and can range from general information about a user, such as age, gender, and zip code, to more detailed and personal information. Such information requests can improve confidence that a user who requests a piece of content has been properly identified. Responses to requests for information can be analyzed to collect information about the user and make determinations about what content to provide to the user. For example, a particular version or portion of the piece of content may be made available to some users and not others based on a user's responses to the requests for information. For example, an automobile manufacturer in the United States may request a piece of content related to the manufacture of an automobile in the United States. A particular version of the piece of content can be determined based on information received in an exchange with the automobile manufacturer for more information. For example, the particular version may contain only automobile parts and accompanying description that are used within the United States and exclude automobile parts that are used outside the United States, as such parts do not pertain to the manufacture of United States automobiles.

As another example, an owner of an automobile may request a piece of content about automobile emissions standards for a particular region or territory. For example, drivers of automobiles in California, United States may be allowed access to only in the emissions standards imposed in California, which may be different than those imposed in Georgia, United States, for example. Therefore, in response to a request for a piece of content that includes information about multiple states, a California driver may receive a piece of content that contains only California emissions standards. Such selective provision of only portions of the piece of content can be based in part on one or more responses from the content requester, i.e., the driver, for example, providing information that the driver's car is registered in California. In some embodiments, however, emissions standards may be provided to all requesters of automobile emissions information as such content requesters may be interested in conducting research, for example, regarding emissions standards in various states within the United States or other countries. In other embodiments, some or all portions of the piece of content may be denied to a content requester.

As another example, different portions of a piece of content related to a medical transaction may be accessed by various members of the medical community. For example, insurance company representatives may access a piece of content and receive only the portions of the piece of content related to financial information necessary to process a claim, such as for a flexible spending account. However, portions of the piece of content related to medical treatment administered to a patient and other health related information such as laboratory results, may not be accessed by insurance company representatives but may be accessed only by physicians, laboratory technicians, and other professionals who provided treatment to the patient. Various other professionals may access the same or different portions of the piece of content. Access to a piece of content related to medical information can be managed in accordance with certain governmental regulations that prohibit certain individuals or institutions from accessing portions of a piece of content that contain a patient's confidential medical records, while allowing certain individuals to access certain portions of the piece of content that allow them to effectively process claims and make payments to physicians and/or medical care facilities.

Restricting access to certain portions of a piece of content as described in the examples above can be implemented in part by a file access management system, which can store access permissions or “security clearance” information for employees in a corporation, for example. Higher level employees may have access to more sensitive information within a piece of content while lower level employees may not access such information. The file access management system may control access based on an employee's title or an employee's unique identification number, as examples. Controlling access to the piece of content at the title level can offer the advantage of requiring less system maintenance. For example, as an employee's title changes due to promotions or lateral assignments, the employee's access to portions of a piece of content may not need to be updated as the file access management system may already have definitions for which pieces of content employees may access based on title. In addition to titles and employee identification numbers, other factors that may distinguish employees from one another may be stored in the file access management system and used to control employees' access pieces of content.

In an exemplary embodiment, the responses to the one or more requests for information can also be used to personalize the process for gaining access to the piece of content. In step-by-step fashion, a request for information can be sent and a response to that request can be received. The response can be analyzed to determine an additional request for information. In another embodiment, the request for additional information can be additionally and/or alternatively based on a user's historical responses, i.e., from prior attempts to access the same or different piece of content. Other factors that can be used to identify a user can also be used such that the user can experience a process for accessing the piece of content that is different from that experienced by other users. Thus, requests for information can vary with respect to the type and amount of information that is requested depending upon user identity and/or user responses. For example, an employee who works for an agency that generates a whitepaper for public dissemination may have to respond to fewer inquiries to access the whitepaper than non-agency employees. Other embodiments can include a process that is sensitive to data that suggests certain users have a low tolerance for entering information to receive a piece of content. Fewer information requests, for example, can be sent to these users to reduce the likelihood that they will be deterred from receiving the piece of content.

A request for a piece of content can be initiated with an attempt to open or view the piece of content. The collection of information can begin, therefore, after the attempt to open the piece of content. According to this embodiment, the piece of content is downloaded before any information about the user is collected. The user may be unable to view or access the piece of content, however, until the user provides information in response to one or more requests for information. This arrangement can be beneficial because it can allow for the collection of information from users who receive the piece of content from sources other than the original source of the piece of content (e.g., from another user). For example, if a user who has provided information to obtain a piece of content forwards the piece of content to a peer, for example, the peer may also have to provide responses to one or more requests for information. The requests for information can be sent to the peer as a result of the peer trying to open, view, or otherwise access the piece of content. Therefore, information may be collected about any user who attempts to open, view, or access the piece of content and not just those users who attempt to download the piece of content from a central location, for example.

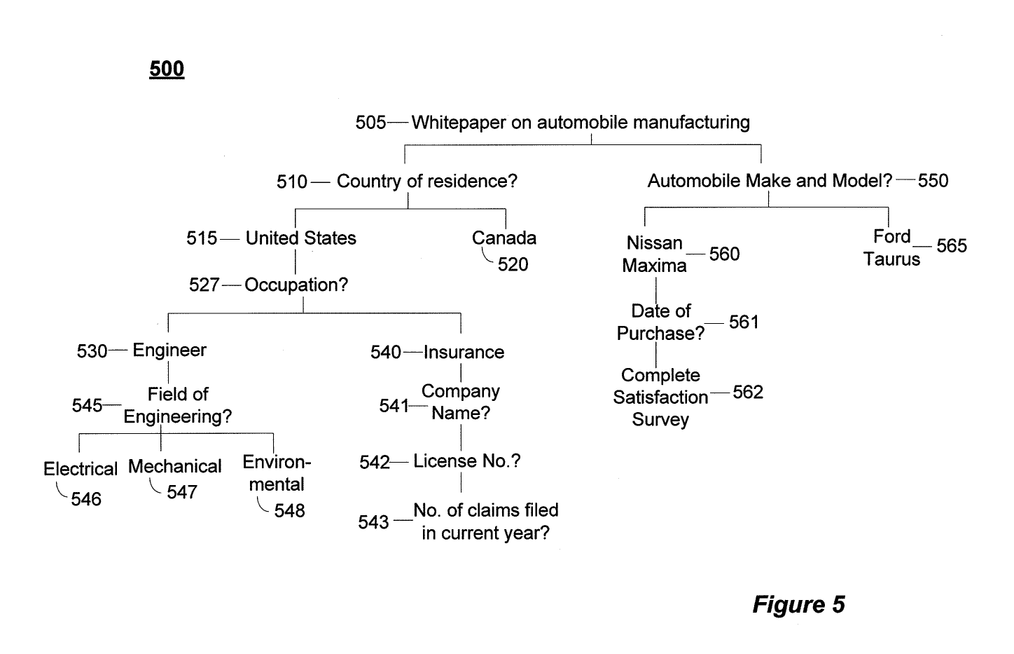

In addition to controlling access to the piece of content, information from the attempt to access and the use of the piece content can be collected. Examples of content use information relate to the duration that particular portions of the piece of content were viewed and information that was used to search the piece of content, such as search terms that are used by a user to locate certain portions within the piece of content. Such access and use information can be used to determine the particular interests of a user and to recommend a piece of content for the user based on those interests. Requests for information can also be tailored to collect information that can be used to improve products and services. For example, a requester of a piece of content related to a particular make and model of an automobile (e.g., a Nissan Maxima at branch 560 in FIG. 5) can be asked to complete a customer survey (branch 562) that contains inquiries based on the date of purchase of the automobile (branch 561). Such inquiries can prompt the requester to specify any trouble or defects that the requester has experienced while operating the automobile, for example. Many more requests for information can be sent to a requester of a piece of content, and the requests may be filtered based on information about the requester that may indicate the requester's tolerance for responding to surveys or voluminous information requests to receive information.

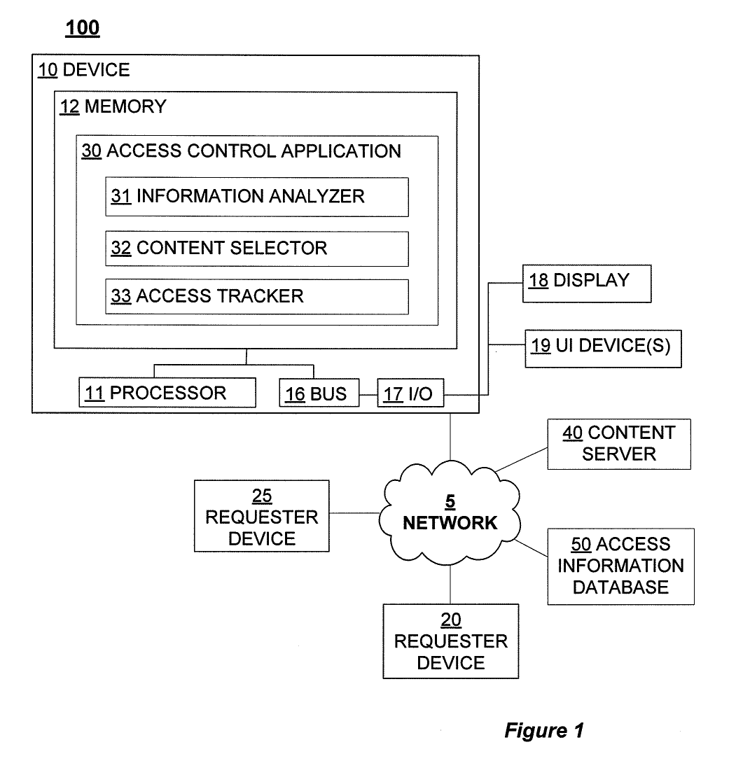

FIG. 1 depicts an exemplary computing environment for selectively providing a piece of content. The methods and systems disclosed herein are also applicable to other computing systems and environments. The environment shown in FIG. 1 comprises a wired or wireless network 5 to which various devices, specifically device 10, requester devices 20 and 25, content server 40, and access information database 50, are connected. In one embodiment, the network 5 comprises the Internet. In other embodiments, other networks, intranets, or combinations of networks may be used: Other embodiments do not involve a network and may, for example, provide features on a single device or on devices that are directly connected to one another, e.g., device 10 may be directly connected to requester device 20. Other alternative networks, computers, and electronic device configurations are also possible. In one configuration, the device 10 accesses the access information database 50 to retrieve information requests based on information received from the requester device 20. The device 10 may also access the content server 40 to retrieve a piece of content and send it to the requester device 20.

As used herein, the term “device” refers to any computing or other electronic equipment that executes instructions and includes any type of processor-based equipment that operates an operating system or otherwise executes instructions. A device will typically include a processor that executes program instructions and may include external or internal components such as a mouse, a CD-ROM, DVD, a keyboard, a display, or other input or output equipment. Examples of devices are personal computers, digital assistants, personal digital assistants, cellular phones, mobile phones, smart phones, pagers, digital tablets, laptop computers, Internet appliances, other processor-based devices, and television viewing devices. The exemplary device 10 is used as a special purpose computing device to provide specific functionality offered by its applications. As an example, device 10 is shown with a display 18 and various user interface devices 19. A bus, such as bus 16, will typically be included in a device.

As used herein the terms “content” and “electronic content” refer to any text, graphics, video, audio, application, executable code, or other material that can be stored on and/or presented on or through a computer or other device. Content can be provided as one or more electronic files.

The term “piece of content,” as used herein, can refer to any electronic document or other bounded physical or digital representation of a body of information that is typically stored as a single unit on an electronic device and transmitted between devices as a single unit. A piece of content can be provided as one or more electronic files. For example, a piece of content may be selected from one or more sources of electronic content and aggregated into a single document. Examples of pieces of content can include whitepapers, articles, technical and other reports, books, and other publications.

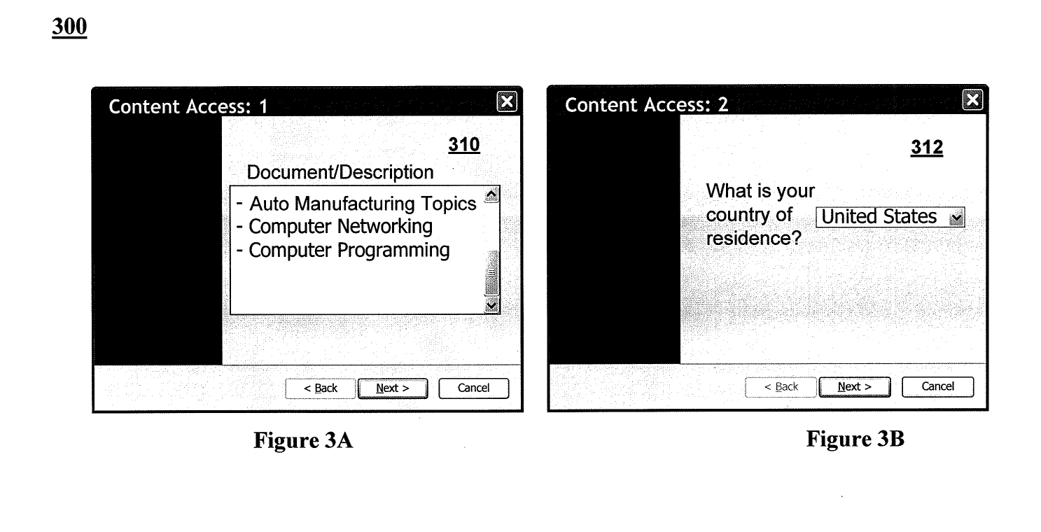

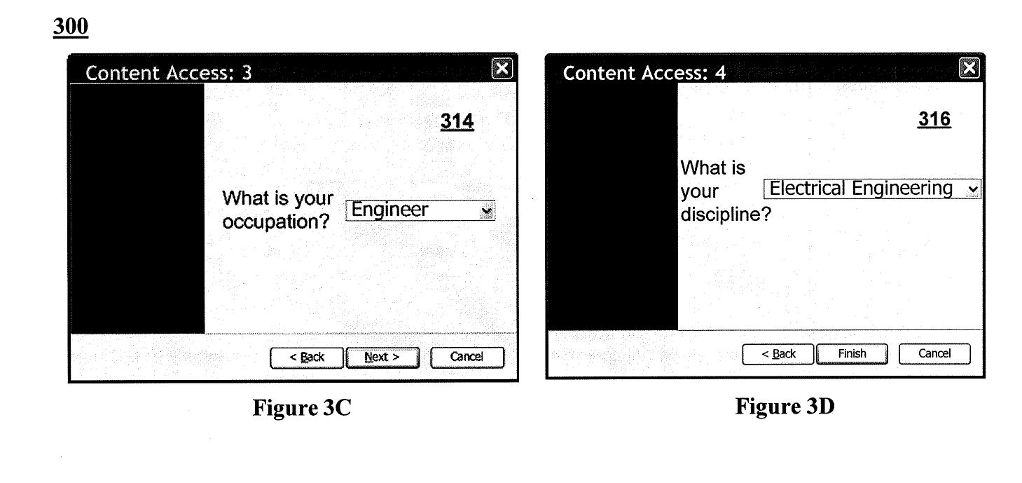

As used herein, the terms “requester” and “user” refer to an individual who uses a device, such as a requester device 20, to request, display, or otherwise use the piece of content. The term “requester device” refers to a device that is used by a requester to request access to a piece of content. A requester device 20 can comprise a graphical user interface (GUI) for communicating with another device. The GUI interface can display information requests and capture responses in a dialogue box format, such as that shown in FIG. 3. In some embodiments, a web browser or similar software application that can interpret HTML, XML, or other markup languages or interpreters capable of displaying a piece of content in a web-based format can be used. Information can also be exchanged using a non-graphical, text based exchange of information in other embodiments.

As used herein, the term “requester-specific” refers to something that differs or that may differ for different requesters. A request for information, for example, can be considered requester-specific if it requests different information depending on the requester to whom the request pertains. For example, a requester-specific request for information for a first requester (such as a requester who is a resident of California) may be different than another requester-specific request from a second requester (such as a requester who is a resident of Georgia) but the same as a requester-specific request for a third requester (such as a requester who is a resident of California like the first requester).

As used herein, the terms “file access management system” and “file system” refer to any system configured to or otherwise used to manage access to any electronic content, whether such content is stored at the system, stored elsewhere, generated dynamically, or provided in some other manner. An exemplary file access management system may store a list of users and the users' access permissions (e.g., read, denied, delete, modify) to a piece of content. Thus, in addition to permitting only certain requesters to access or read a piece of content, a file management system may be configured to also permit certain requesters to modify a piece of content. An “access control list” may be used to store requester access information in a location accessible to a file access management system. An access control list can be used to specify which users have access to which objects or pieces of content.

A computer-readable medium may comprise, but is not limited to, an electronic, optical, magnetic, or other storage device capable of providing a processor with computer-readable instructions. Other examples comprise, but are not limited to, a floppy disk, CD-ROM, DVD, magnetic disk, memory chip, ROM, RAM, an ASIC, a configured processor, optical storage, magnetic tape or other magnetic storage, flash memory, or any other medium from which a computer processor can read instructions. The instructions may comprise processor-specific instructions generated by a compiler and/or an interpreter from code written in any suitable computer-programming language, including, for example, C, C++, C#, Visual Basic, Java, Python, Perl, JavaScript, and ActionScript.

In FIG. 1, device 10 comprises a memory 12 that contains an access control application 30. The access control application 30 can comprise an information analyzer 31, a content selector 32, and an access tracker 33. Each of these modules can be implemented as individual modules that provide specific functionality of the access control application 30. For example, the information analyzer 31 can determine particular additional requests for information based on responses received from a requester device 20. The content selector 32 can use the responses to select a piece of content that is relevant to the requester device 20. After the piece of content has been displayed at the requester device 20, the access tracker 33 can store data related to the attempted access and/or use of the piece of content. Such data can be used to determine future information requests and pieces of content for requester devices 20. In other embodiments, the functionality provided by the information analyzer 31, the content selector 32, and the access tracker 33 can be provided by fewer or more modules.

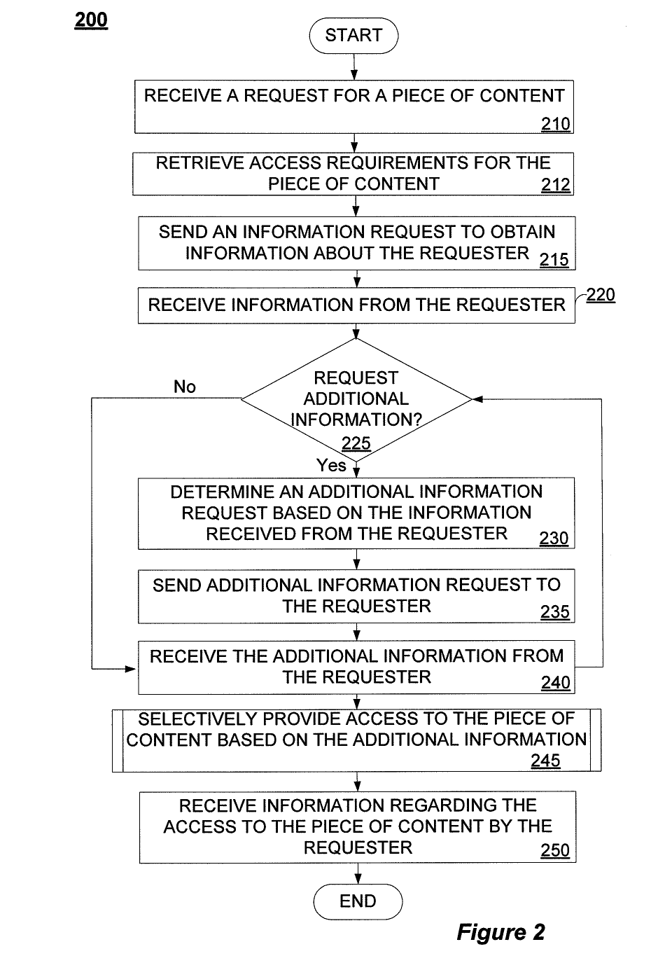

FIG. 2 is a flow chart illustrating an exemplary computer-implemented method 200 of selecting a piece of content based on information received in response to requests for information. A request for a piece of content can be received at block 210. For example, the request can be received at the device 10 in response to the requester device 20 attempting to download the piece of content or attempting to open the already downloaded piece of content at the requester device 20. An example of attempting to open the piece of content involves a user selecting “File” and then “Open” in an application such as a document viewing or editing application. Other applications that can display a piece of content can also be used. In another example, a requester uses a web browser at a requester device 20 to attempt to download a document from a web site or other server.

In some embodiments, a request for a piece of content can be received in response to events other than “open” that occur at the requester device 20. For example, the request for a piece of content can be made at the selection of a “next page” or equivalent button such that a user can view an abstract or summary portion of the piece of content, for example, but no more until the user enters information required to receive the remaining portions of the piece of content. Dragging a scroll bar in an application on the requester device 20 to view more text can have a similar effect. In other embodiments, the request for a piece of content can be prompted at the device 10. For example, upon detecting the availability of a new piece of content that is similar to a piece of content that has been previously accessed by a requester device 20, the device 10 can send a message to the requester device 20 that a new piece of content is available. Clicking on such a message can begin the information collection process for receiving the new piece of content.

Upon receiving a request for a piece of content at block 210, access requirements for a piece of content can be determined at block 212. For example, the device 10 can obtain such information by accessing the access information database 50. The access requirements can specify the level of security required to access the piece of content. Security level may vary from piece of content to piece of content and from user to user. For example, a low level of security associated with a piece of content may require a particular requester to provide only general information, such as name and address. A high level of security may, however, require the same or a different requester to provide more specific information, such as a pass code that was generated specifically for the requester. Many additional and/or alternative levels of security can be used for the piece of content and each level can be associated with various requests for information. Lower levels of security, for example, can be associated with fewer requests for information while higher levels of security can be associated with more requests for information. As an example, security level 4 of 5 (on a scale of 1-5) can require a first requester to specify a user name, password, pass code, and date of birth. A lower level request, e.g., security level 3 may require a second requester to provide the same information without requiring input for a date of birth.

The access information database 50 can store the access requirements in the example above. An example database record of fields and their associated values can include: name of content requested: automobile manufacturing; security level: 4; information requests: user name, password, pass code, date of birth, where the colon in the example database record separates the database field from its value, i.e., field:value. In some embodiments, the requester device 20 may receive a different piece of content than that requested based on responses received from the requester device 20. In such a case, the access information database 50 may also contain the name of the different or alternate piece of content to be sent to the requester device 20.

In addition to access requirements, the access information database 50 can also store other information related to the piece of content, such as information requests, responses to the information requests, various analytics related to an accessed piece of content, a requester's preferences for pieces of content, and encryption keys used to encrypt information sent from the device 10 to the requester device 20. Information related to the piece of content can additionally or alternatively be stored in the metadata for the piece of content.

In one embodiment, the access requirements for a piece of content can be configurable such that an author of the piece of content, for example, can specify the access requirements for accessing the piece of content. For example, the author may specify certain information requests and acceptable responses to the information requests to restrict the piece of content to certain requesters or requesters who meet certain criteria. The access requirements can be stored in the access information database 50 in one embodiment.

A piece of content can have an identifier such that when a requester attempts to open the piece of content, the identifier can be sent to the device 10 and used to access a particular set of access requirements (e.g., information requests) for the piece of content. In the example database record above, the identifier can be the “name of the content requested.”The identifier can otherwise be any unique name or string of characters that associates a piece of content with information requests. Identifiers may also be linked to other identifiers in the access information database 50. For example, a set of information requests associated with one identifier may be aborted in favor of another set of information requests associated with another identifier, depending on the responses received at the device 10. This process can be repeated until all required information is received from the requester. A requester can receive the piece of content associated with the identifier only after access to the piece of content has been granted, in one embodiment. If all required information is not received or access to the piece of content is otherwise denied, a link between the identifier and the piece of content can be broken or disassociated at the access information database 50, for example, such that the piece of content is no longer associated with the identifier and the requester therefore does not receive the piece of content.

In addition to storing access requirements in the access information database 50, the access requirements can be embedded in the application that is used to display the piece of content. An application can prompt the requester for responses to one or more information requests, collect the responses, and send the responses to the device 10 for further analysis and storage. Instead of configurable access requirements, some embodiments may include default access requirements for a piece of content that belongs to a particular category of information.

At block 215, an information request can be sent to a requester device 20 to obtain information about a requester. This initial request can be obtained from a predefined list of inquiries that make up access requirements for a piece of content. For example, any request for a piece of content (e.g., an automobile manufacturing whitepaper) can be followed by a request for country of residence. In some embodiments, the initial request can be based on information already known about the requester. Such information can be a geographical location as determined from an IP address of the requester's device (e.g., requester device 20), information associated with the requester's login and password credentials, a hardware identifier associated with a requester's device such as a smart card or an identifier for a central processing unit (CPU) or another processor, or otherwise any information that is stored about the requester or the requested piece of content prior to receiving a response to an information request related to a pending request for the piece of content.

Information in response to the information request is received at block 220. An example country of residence is “United States.” At decision block 225, a determination can be made as to whether sufficient information has been received to grant access to the piece of content or whether additional information is required. The information requested from each requester device 20 can vary such that each requester device 20 may be required to provide a different type and amount of information. For example, a requester device 20 that has an IP address consistent with a device that is located on an internal network, such as an intranet, may have to provide fewer responses to gain access to a piece of content than other devices located external to the network. Such devices can be associated with employees, for example, whose identity is known and from whom only a limited number of responses may be required. Requester devices 20 that request a piece of content over the Internet, however, may be less trusted and therefore may be subjected to numerous additional requests for information.

If additional information is required, an additional information request can be determined at block 230 based on the information received at block 220. In one embodiment, a decision tree that contains a list of information requests and acceptable responses can be used. Each acceptable response can have a branch that contains additional information requests. For example, in FIG. 5, acceptable responses to the information request for a particular make and model of an automobile are “Nissan Maxima” at branch 560 and “Ford Taurus” at branch 565. In some embodiments, any number of responses can be accepted (e.g., “Company Name”) at branch 541 in FIG. 5. Not all information that is collected will necessarily be used to determine an additional information request or whether to allow access to the piece of content to the requester. Some information can be used by various industries to develop better products and services for its customers by, for example, detecting trends or recurring issues in received information. Various techniques other than a decision tree that can associate data, such as a relational database, can be used to group information requests with acceptable responses.

Responses that may be deemed unacceptable can be handled in various ways. In one embodiment, access to the requested piece of content can be denied. In another embodiment, instead of denying entirely access to the piece of content, general information related to the piece of content can be provided so that the requester can receive at least some portions of the piece of content, even if those portions are not tailored to the requester's particular interests. In yet another embodiment, a separate branch of the decision tree can be traversed such that the requester receives a new set of information requests that require their own responses. Such a new set of requests may result in the requester receiving a different piece of content than that originally requested.

Various processes can be used to enforce or control access to a piece of content by a requester. For example, a piece of content sent to a requester via an encrypted channel can be decrypted only after access to the requester has been granted. The encrypted channel may not be decrypted for a requester who has not been granted access to the piece of content and therefore such a requester may not view the piece of content. In addition or alternative to a decryption key, a pass code, or another secret string of characters required to gain access to information, may be sent to a requester who has been granted access to the piece of content. Upon entering the pass code at a requester device 20, a requester may gain access to the piece of content.

Each pass code can be uniquely associated with a piece of content and a requester who receives the piece of content. Each time a piece of content is provided to a requester, the piece of content, the requester who received the piece of content, and optionally the pass code required to access the piece of content, can be recorded at the access information database 50. Such recorded information can be analyzed to determine whether a requester has previously accessed the piece of content, and if so, the date and time the requester accessed the content, and the requester's requester device 20 to which the piece of content was sent, as examples.

FIG. 3 will now be described in conjunction with FIG. 5 to illustrate an exemplary process where an information request is determined based on a response to a previous information request. The process can begin with a request for user name and password to determine the identity of a requester. Selecting a whitepaper on auto manufacturing in FIG. 3A can trigger a request for the country of residence in FIG. 3B. Such an information request can be consistent with knowledge that auto manufacturing can be country-specific, e.g., some auto parts may be used in some countries while not in others. As shown in FIG. 5, “country of residence” at branch 510 is one of two predefined information requests (the other is “automobile make and model” at branch 550) that can be sent to requesters that select a piece of content related to auto manufacturing at branch 505. Two possible responses to the “country of residence” information request can be “United States” at branch 515 or “Canada” at branch 520. Although two information requests and two acceptable responses are shown, numerous other requests and responses may exist in other embodiments.

Upon receiving a response of “United States” in FIG. 3B (branch 515 of FIG. 5), an additional information request for an occupation can be requested in FIG. 3C (branch 527 of FIG. 5). The request for occupation can be consistent with knowledge that the piece of content contains information about various professions. Thus, in one embodiment, specifying “engineer” as an occupation can be interpreted to provide only portions of the piece of content that is relevant to engineers. Another additional information request, for a specific discipline of engineering, can be made at FIG. 3D. The requested piece of content can be obtained upon specifying the discipline and clicking the “Finish” button in FIG. 3D.

The request to receive the occupation and field of occupation can be obtained from the mapping in FIG. 5, where a response of “engineer” at branch 530 leads to the more specific request for the field of engineering at branch 545. As shown in FIG. 5, the requester selects “electrical engineering” at branch 546. Other possible responses to field of engineering are “mechanical” at branch 547 and “environmental” at branch 548. A response of “insurance” at branch 540 instead of “engineering” can lead to a relatively higher number of requests for information, e.g., for company name at branch 541, license number of the requester at 543, and number of claims filed in current year at branch 543. The request for more information for insurance-related content can be consistent with a desire to collect more information about requesters in the insurance industry. Many other industries, groups, or requesters can be targeted such that more and/or different information is collected about them. Many more information requests can be made and responses received in the fashion described above.

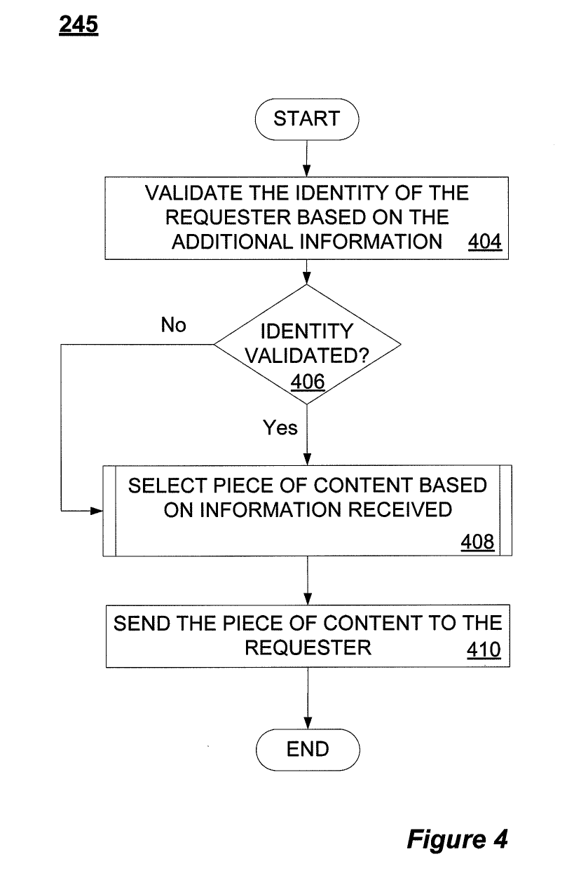

Returning now to FIG. 2, selective access to the piece of content can be provided at block 245. As indicated at block 404 of FIG. 4, selective access can include validating the identity of the requester based on the additional information (i.e., a response to an additional request for information) received from the requester. For example, according to one embodiment, the additional information can be compared to historical information received from the requester to validate the identity of the requester. Any information that is inconsistent with previously submitted information can invalidate a requester's access to the piece of content. Moreover, the level of trust given to requesters can vary. Requesters in a certain geographical location, for example, may be trusted more than requesters in other geographical locations and thus may be validated more quickly (e.g., with fewer requests for additional information) than other requesters. Also, requesters belonging to certain professions or having certain titles within a corporation may be trusted more than other requesters. For example, executives of a corporation may have access to the vast majority of a corporation's pieces of content upon providing little additional information while temporary employees performing less critical work functions may be subjected to numerous requests for information. Any number of other factors that distinguish one requester from another can be used to validate identity. Examples include information stored in a cookie, networking characteristics such as IP address, and device hardware characteristics such as Media Access Control (MAC) address.

In some embodiments, an internal document policy that defines which requesters can access which pieces of content can be used to validate a requester's access to a piece of content. A requester's access may be checked against the internal document policy before access to a piece of content is granted.

Selective access to the piece of content at block 245 of FIG. 2 can also include selecting the piece of content based on information received about the requester at block 408. In one embodiment, a particular version of the piece of content can be provided. For example, an automobile manufacturing document may contain a piece of content on multiple makes and models of automobiles, and each make and model may constitute a separate version in the document. An automobile owner who provides information on a particular make and model can receive the version of the document that corresponds to such. Owners of different makes and models can receive a different version of the piece of content. In one embodiment, a requester may receive a piece of content that is different from that originally requested. For example, the automobile owner in the example above may select a specific version of the piece of content but may ultimately receive a different version, e.g., the version that pertains to the make and model of the owner's automobile.

In addition to corresponding to a particular version, the piece of selected content can be a portion of a larger body of content. In one embodiment, the piece of content can be selected from multiple sections of one document or from multiple documents and aggregated into a single document for the requester. The relevant information within larger text portions can be parsed or can be identified by tags, headings, definitions in metadata, or database relationships, as examples.

Selective access to the piece of content can also include providing the piece of content. For example, the device 10 can access the content server 40 to select the piece of content and send the piece of content to the requester device 20 at block 410. The content server 40 can store all available pieces of content according to this example. The piece of content can be sent to the requester device 20 as a result of the requester device 20 sending a request to the device 10 to view the piece of content in response to the requester device 20 receiving an indication to open the piece of content. A piece of content that has been sent to the requester device 20 can be forwarded to the requester device 25. Although FIG. 1 shows only two requester devices that can receive a piece of content from the device 10, many more requester devices can also receive the piece of content. Because the piece of content is not displayed until the “open” or equivalent event on the requester device 25, the requester device 25 may have to meet access requirements (e.g., respond to information requests) in order to display the piece of content in similar fashion as the requester device 20. In one embodiment, the process for accessing the piece of content for the requester device 25 can begin at block 210 in FIG. 2 as it did for the requester device 20. Variations in the process may exist in other embodiments. For example, the device 10 may record information on which requester device 20 forwarded the piece of content to the requester device 25 by storing such information in the access information database 50 or another storage device. Less restrictive access to the piece of content may be provided to a requester device 25 that received the piece of content from a certain requester device 20, e.g., a requester device 20 for which a higher level of trust exists.

Information related to accessing and using the displayed piece of content (e.g., access information) can be recorded at block 250. The tracked information can be used to determine a profile for a requester based on information received previously about the requester. A requester's profile can be used to determine future pieces of content for the requester. For example, if a requester spends more time on one page of a document that contains particular subject matter, that subject matter can be identified as one of particular interest to the requester. Subsequently, advertisements and other promotional materials, for example, that are related to the area of interest can be suggested to the requester. In one embodiment, such materials can be included with a requested piece of content and displayed within an application that is used to view the piece of content. In another embodiment, the requester can be notified of such content upon accessing the device 10 and requesting an additional piece of content. In yet another embodiment, the requester can receive a message (e.g., electronic mail) from the device 10 when the piece of content becomes available.

Examples of other information that can be stored are keywords used to search a piece of content, pages of a document that were printed or modified, or otherwise any request received at the requester device 20 that can be associated with the piece of content. In one embodiment, the piece of content is included in an application that offers various functions that assist a user with using the piece of content. The selection of any of these functions can result in sending data related to use of the piece of content to the device 10.

### General

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting. While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

It should be understood that the foregoing relates only to certain embodiments which are presented by way of example rather than limitation. While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure does not preclude inclusion of such modifications, variations and/or additions to the present subject matter as would be readily apparent to one of ordinary skill in the art upon review of this disclosure.

1. A computer-implemented method comprising:
receiving, at a first computer device, a content request for accessing a piece of content by a content requester, the content request identifying the piece of content and information about the content requester who is requesting access to the piece of content, the piece of content being a text based document;
determining, at the first computer device, based on information already known about the content requester that there is insufficient information to determine access rights of the content requester, wherein a profile comprises the information already known about the content requester;
sending from the first computer device a requester-specific information request requesting additional information from the content requester to allow determination of the access rights of the content requester
receiving the additional information at the first computer device;
developing the profile based at least in part on the additional information to allow determination of the access rights of the content requester based on the profile and access requirement information; and
selectively, at the first computer device, providing access to a particular version of the piece of content, wherein the particular version is determined based at least in part on the access rights of the content requester based on the profile, and the particular version is a previously generated text based document.

2. (canceled)

3. The method of claim 1 further comprising selectively providing access by providing the piece of content.

4. The method of claim 1 further comprising selectively providing access by allowing a second computer device to open the piece of content.

5. (canceled)

6. The method of claim 1 wherein selectively providing access is further based on a geographical location of a second computer device, the second computer device requesting access to the piece of content.

7. The method of claim 1 further comprising validating, at the first computer device, an identity of the content requester based on the additional information.

8. The method of claim 7 wherein validating comprises comparing the additional information with information previously received at the first computer device.

9. The method of claim 1 wherein the content request is initiated by an attempt to open a document on a second computer device.

10. The method of claim 1 wherein the content request is initiated by an attempt to download a document from the first computer device to a second computer device.

11. The method of claim 10 wherein the content request is initiated by an attempt to download a first version of a document from the first computer device to a second computer device, wherein selectively providing access to the piece of content comprises providing access to a second version of the document different from the first version of the document.

12. A system comprising:
a client device;
a server storing a piece of content; and
a file access management system configured to perform the steps comprising:
receiving a content request for accessing the piece of content by a content requester at the client device, the content request identifying the piece of content and information about the content requester who is requesting access to the piece of content, the piece of content being a text based document;
determining based on information already known about the content requester that there is insufficient information to determine access rights of the content requester, wherein a profile comprises the information already known about the content requester;
sending a requester-specific information request requesting additional information from the content requester at the client device to allow determination of the access rights of the content requester;
receiving the additional information;
developing the profile based at least in part on the additional information to allow determination of the access rights of the content requester based on the profile and access requirement information; and
selectively providing access to a particular version of the piece of content, wherein the particular version is determined based at least in part on the access rights of the content requester based on the profile, and the particular version is a previously generated text based document.

13. (canceled)

14. The system of claim 12 wherein the content request is initiated by an attempt to download a first version of a document from the server to the client device over a network, wherein selectively providing access to the piece of content comprises providing access to a second version of the document different from the first version of the document.

15. The system of claim 12 wherein selectively providing access comprises allowing the client device to open the piece of content.

16. A non-transitory computer-readable medium on which is encoded program code, the program code comprising:
program code for receiving, at a first computer device, a content request for accessing a piece of content by a content requester, the content request identifying the piece of content and information about the content requester who is requesting access to the piece of content, the piece of content being a text based document;
program code for determining, at the first computer device, based on information already known about the content requester that there is insufficient information to determine access rights of the content requester, wherein a profile comprises the information already known about the content requester;
program code for sending from the first computer device a requester-specific information request requesting additional information from the content requester to allow determination of the access rights of the content requester;
program code for receiving the additional information at the first computer device;
program code for developing the profile based at least in part on the additional information to allow determination of the access rights of the content requester based on the profile and access requirement information; and
program code for selectively, at the first computer device, providing access to a particular version of the piece of content, wherein the particular version is determined based at least in part on the access rights of the content requester based on the profile, and the particular version is a previously generated text based document.

17. The computer-readable medium of claim 16 wherein the content request is initiated by an attempt to open a document on a second computer device.

18. The computer-readable medium of claim 16 wherein the content request is initiated by an attempt to download a document from the first computer device to a second computer device.

19. The computer-readable medium of claim 16 wherein the content request is initiated by an attempt to download a first version of a document from the first computer device to a second computer device, wherein selectively providing access to the piece of content comprises providing access to a second version of the document different from the first version of the document.

20. The computer-readable medium of claim 16 further comprising validating, at the first computer device, an identity of the content requester based on the additional information.

21. The method of claim 1 wherein there are multiple versions of the piece of content.

22. The method of claim 21 further comprising selectively providing access to different versions of the same piece of content to a plurality of content requesters based at least in part on access rights of the plurality of content requesters based on profiles of the plurality of content requesters.

23. The method of claim 7 wherein the identity of the content requester is validated based on a level of trust of the content requester.

24. The method of claim 23 wherein the level of trust is based on the job title of the content requester within a professional organization.
